(19) United States
(12) Patent Application Publication
(10) Pub. No.: US 2014/0011004 A1
(43) Pub. Date: Jan. 9, 2014

(54) HIGH RESOLUTION PATTERNING ON CONDUCTIVE FABRIC BY INKJET PRINTING AND ITS APPLICATION FOR REAL WEARABLE DISPLAYS

(71) Applicants: Gregory Allen Sotzing, Storrs, CT (US); Yujie Ding, Naugatuck, CT (US)

(72) Inventors: Gregory Allen Sotzing, Storrs, CT (US); Yujie Ding, Naugatuck, CT (US)

(73) Assignee: The University of Connecticut, Farmington, CT (US)

(21) Appl. No.: 13/719,715

(22) Filed: Dec. 19, 2012

Related U.S. Application Data
(60) Provisional application No. 61/578,035, filed on Dec. 20, 2011.

(51) Int. Cl. G02F 1/15

(52) U.S. Cl. CPC G02F 1/15
USPC 428/196; 427/58; 2/69

(57) ABSTRACT

Disclosed herein are methods of using inkjet printing for high resolution patterning of conductive fabric in the preparation of electrochromic devices. The process finds utility in the preparation of wearable electronic garments and other electrochromic devices.

### CROSS REFERENCE TO RELATED APPLICATION

This application claims the benefit of U.S. Provisional Application No. 61/578,035 filed Dec. 20, 2011, which is hereby incorporated by reference in its entirety.

### BACKGROUND

An electrochromic device is a self-contained, two-electrode (or more) electrolytic cell that includes an electrolyte and one or more electrochromic materials. Electrochromic materials can be organic or inorganic, and reversibly change color when oxidized or reduced in response to an applied electrical potential. Electrochromic devices are therefore constructed so as to modulate incident electromagnetic radiation via transmission, absorption, or reflection of the light upon the application of an electric field across the electrodes. The electrodes and electrochromic materials used in the devices are dependent on the type of device, i.e., absorptive/transmissive or absorptive/reflective.

Currently known wearable electronic garments are typically made by embedding displays, sensors, or switchers into the fabric or by using metal wires. Such devices resulted in garments that are uncomfortable to wear, difficult to clean, and which cannot be stretched or folded as normal garments.

One of the challenges during the development of wearable electronics is how to integrate the electronic functions without affecting the hand and comfort level of the garments. While various products and prototypes have been made for entertainment, health monitoring, athletic training and fashion applications, the common approach continues to be a combination of normal textile and the implant of an external device. Some researchers have reported incorporation of conductive particles such as carbon nanotubes or polypyrrole into the textile matrix in attempt to achieve a conductive composite fabric. However, methods that involve harsh oxidants or result in black or nearly black end-products are not suitable for applications such as adaptive camouflage, biomimicry, wearable displays and fashion.

Furthermore, known processes for applying electrochromic material to a substrate have various disadvantages. Stencil and screen printing have been used to pattern on fabrics. These processes have disadvantages of limited resolution and waste of material.

There remains a need in the art for processes which allow for high resolution patterning and pixilation on conductive fabric and high resolution patterning in the formation of electrochromic devices.

### BRIEF SUMMARY OF THE INVENTION

In one embodiment, a method of forming a fabric electrochromic device comprises inkjet printing a conductive material onto a fabric substrate and inkjet printing an electrochromic material such as an electrochromic polymer or electrochromic polymer precursor to form an electrochromic device.

Also disclosed herein are electrochromic devices prepared by inkjetting processes.

### BRIEF DESCRIPTION OF THE DRAWINGS

The components in the drawings are not necessarily to scale, emphasis instead being placed upon clearly illustrating the principles of the embodiments described herein. Moreover, in the drawings, like reference numerals designate corresponding parts throughout the several views.

FIG. 1 (A)-(F) Images of inkjet-printed UCONN logo of (FIG. 1 A) precursor polymer, and (FIG. 1 B) backside of printed fabric; assembled electrochromic device in (FIG. 1 C) neutral state and (FIG. 1 D) oxidized state. FIG. 1 (E) and FIG. 1 (F) are microscopic images of part of the logo on fabric, the UCONN logo pattern has a diameter of ca. 40 mm.

FIG. 2 (A)-(B) FIG. 2 (A) shows inkjet-printed UCONN logo using PBEDOT-T-Si[Octyl]₂ on ITO-PET substrates. FIG. 2 (B) shows color coordinates comparison between (left) inkjet print patterns on fabric (triangular) and on PET-ITO (circle); (right) inkjet print patterns (triangular) and spray coated patterns (square).

FIG. 3 (A)-(E) Microscopic images of (FIG. 3 A) spandex threads after soaked in PEDOT:PSS solution; (FIG. 3 B) spandex printed PEDOT:PSS with 10% EG and 10% DMF additive, the white part is the base fabric without printing, note the comparison of the underlying layer in red circle before and after printing; (FIG. 3 C) spandex printed with pristine PEDOT:PSS after rubbing test; (FIG. 3 D) spandex printed with PEDOT:PSS with 10% EG and 10% DMF additive after peeling test. FIG. 3 (E) illustrates inkjet-printed PEDOT:PSS without any additive (1 cm×2 cm), from top to bottom: printed 15, 20, 25, 30, 35, 40, 45, 50, 100 layers.

FIG. 4 Microscopic image of a piece of spandex printed under 20% stretch, note the difference between the underlying layer printed with PEDOT-PSS and the pristine spandex matrix.

FIG. 5 (A)-(B) FIG. 5 (A) illustrates all the electrochromic material coated on the top stainless steel changed color when potential was applied; the diameter of the thread is about 40 μm. FIG. 5 (B) illustrates that with conductive fabric, only electrochromic material that is in close range with the cross junction switched from red to blue.

FIG. 6 is a schematic of an example of utilizing the localized color change on spandex substrates.

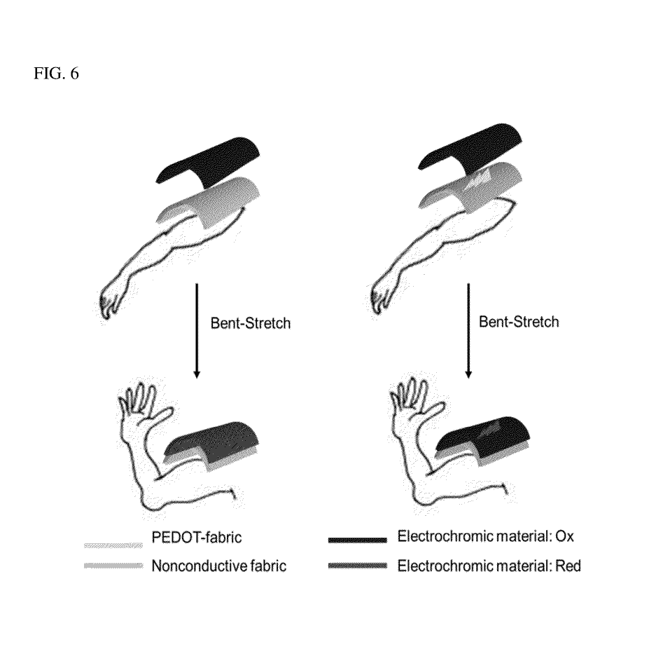

FIG. 7 (A)-(C) FIG. 7 (A) is a 3-D schematic illustration and FIG. 7 (B) is a cross-section of the electrochromic device built on woven structure substrates. FIG. 7 (C) is precursor polymer sprayed on spandex fabric and after conversion to polythiophene.

FIG. 8 (A)-(D) Fabric ECDs assembled by (FIG. 8 A) two pieces of woven stainless steel mesh electrodes; (FIG. 8 B) one piece of stainless steel mesh and one piece of spandex as the working electrode; (FIG. 8 C) two pieces of PEDOT impregnated spandex electrodes. (FIG. 8 D) Chronocoulometry responses between −2 V and +2 V (vs. Ag/Ag+) for assembled devices whose working electrode/counter electrode configurations are metal mesh/metal mesh (top), spandex/metal mesh overlaid with spandex/spandex (bottom).

FIG. 9 (A)-(B) FIG. 9(A) is a CIE Lu′v′ color coordinate plot for metal mesh (triangles) and spandex (circles) devices; the blue-filled shapes represent the oxidized state and the red-filled shapes represent the neutral state. FIG. 9(B) is a comparison of stretched (circles) versus non-stretched (squares) fabric.

FIG. 10 (A)-(B) Image analysis of the iris effect on devices fabricated by FIG. 10 (A) two pieces of spandex electrodes and FIG. 10(B) one spandex electrode and one piece of stainless steel mesh.

FIG. 11 (A)-(D) FIG. 11 (A) and FIG. 11 (B) show a fabric device with electrochromic materials coated on both sides and undergo opposite color change when switched; the other side of the device is shown in the picture by placing a mirror opposed to the device. FIG. 11 (C) shows a the three electrodes design of ECDs, the middle piece will have no active material coated on it and function as the counter electrode. FIG. 11 (D) is the three electrodes device showing the same color change on both sides; the back side of the device is a mirror image.

### DETAILED DESCRIPTION OF THE INVENTION

Disclosed herein are processes of inkjet printing of conductive polymers (electrochromic material) for high-resolution electrochromic pattern formation on fabric substrates, including conductive fabrics. The process is used to pattern color-changing polymer materials or to deposit the base conductor onto a fabric matrix, or both, to form fabric electrochromic devices. Inkjet printing offers non-contact, flexible, clean and high resolution deposition of ink. Conductive fabrics, with their lower conductivity, provide an advantage for device fabrication in terms of localizing the color switching. By combining the fine patterning achieved by the electrochromic material deposition via inkjetting and the localization feature, pixilation on fabric can be realized leads to the fabrication of wearable fabric displays.

Inkjet-printing processes apply small droplets of ink which allows for very precise deposition of the ink onto fabrics. The small quantity of ink material in each droplet also prevents the material from bleeding out to surrounding threads and therefore results in sharp images.

In one embodiment, high resolution electrochromic patterns are inkjet printed onto conductive fabric substrates such as conductive spandex substrates. In another embodiment, the conductive fabrics have a relatively low conductivity of ca. 0.1 S/cm and therefore can localize the electrochemical color change, a feature that cannot be easily achieved by more conductive substrates.

In another embodiment, organic conductors, such as PEDOT-PSS, can be inkjetted onto a fabric substrate to form a design patterned conductive fabric electrode.

In yet another embodiment, both the organic conductor is inkjet patterned on a fabric substrate as well as the electrochromic material.

In another embodiment, additives are used to enhance the conductivity (e.g. by 150%) and improve the stability of the printed patterns.

Incorporated by reference in their entirety are US Published Application 2010/0245971 to Sotzing et al. filed Mar. 19, 2010 and U.S. Ser. No. 61/448,293 to Sotzing et al. filed Mar. 2, 2010.

U.S. Ser. No. 61/448,293 discloses stretchable polymeric electrolytes for use in stretchable electrochromic applications. These polymeric electrolytes can be used to prepare the fabric electrochromics prepared by inkjet printing processes disclosed herein.

The fabric electrochromic devices prepared by inkjet printing the electrochromic and the conductor can comprise reflective colors on the surface allowing for the possibility to have two different colors on different side of the device. By modifying the device structure, color changes on two sides could be the same or the opposite. This feature would be especially useful for sign applications in which different logos or images could be designed on each side.

The formation of a fabric electrochromic device comprises inkjetting a conductor, an electrochromic material, or both onto a woven substrate.

Polymeric color changing material and/or conductors can be prepared into inkjettable inks by dissolving the materials into an appropriate solvent to achieve a viscosity of about 5 to about 30 cP, specifically about 10 to about 20 cP, and more specifically about 13 to about 17 cP.

The formation of an inkjettable electrochromic materials or electrochromic polymer precursor mixture generally comprises forming a mixture of the material to be inkjetted with a solvent. The solvent can be an organic solvent or combination of an organic solvent and water. Exemplary organic solvents include dichloromethane (DCM), toluene, N,N-dimethyl formamide (DMF), propylene glycol monomethyl ether acetate (PGMEA), propylene glycol monomethyl ether (PGME), acetone, methanol, and ethanol.

During inkjet printing, the drop spacing can be about 35 to about 45 μm, specifically about 38 to about 42 μm, and more specifically about 40 μm.

Fabric substrates can be stretched during printing to allow ink to penetrate the woven structure. Exemplary amount of stretching of the device during printing can be up to about 60%, specifically about 5 to about 40%, more specifically about 10 to about 30%, and yet more specifically about 15 to about 20%. The fabric substrate can be relaxed after printing, specifically to its original length.

An exemplary inkjettable conductor comprises PEDOT:PSS, optionally including a glycol additive to improve the conductivity or DMF to aid in adhesion, or both a glycol additive and DMF.

The electrochromic device prepared using inkjet printing can employ a fabric substrate, specifically a stretchable fiber or fabric. The stretchable electrochromic fiber or fabric is both flexible and expandable.

Stretchability for a given material can be characterized by elongation at break and the ability of elastic recovery. Elastomeric material such as spandex, have a large elongation at break value (up to about 800% to about 900%) and recover to their original form when the force is removed within a certain range. Different fabrics have different stretchablility depending on the type, fiber/yarn diameter, fiber bundle, etc. In general, common fabrics, such as silk or cotton, have little to no stretchability as compared to spandex. However, there are many commercially available products which contain small amount of spandex (about 5%) that have sufficient stretchability for use as stretchable substrates herein.

The stretchable substrate includes stretchable fibers, such as spandex fibers; stretchable fabric such as spandex fabric or fabric prepared from blends of spandex and other materials; stretchable nonfabric, porous substrates (e.g. foamed thermoplastic polyurethane). Exemplary stretchable substrates include two way or four way stretchable fabrics such as spandex.

In specific embodiments, the stretchable substrate is a stretchable electrochromic substrate. The stretchable electrochromic substrate can be a stretchable electrochromic fiber or fabric prepared from electrochromic materials; stretchable fiber or fabric prepared from non-electrochromic materials which have been coated or impregnated with an electrochromic material specifically applied by an inkjettable process; or a combination thereof.

Other exemplary stretchable, electrochromic substrates include those described in copending U.S. Published Application No. 2010-0245971A1 to Sotzing et al., hereby incorporated by reference.

The term “fiber” as used herein includes single filament and multi-filament fibers, i.e., fibers spun, woven, knitted, crocheted, knotted, pressed, plied, or the like from multiple filaments. No particular restriction is placed on the length of the fiber, other than practical considerations based on manufacturing considerations and intended use. Similarly, no particular restriction is placed on the width (cross-sectional diameter) of the fibers, other than those based on manufacturing and use considerations. The width of the fiber can be essentially constant, or vary along its length. For many purposes, the fibers can have a largest cross-sectional diameter of 2 nanometers and larger, for example up to 2 centimeters, specifically from 5 nanometers to 1 centimeter. In an embodiment, the fibers can have a largest cross-sectional diameter of 5 to 500 micrometers, more particularly, 5 to 200 micrometers, 5 to 100 micrometers, 10 to 100 micrometers, 20 to 80 micrometers, or 40 to 50 micrometers. In one embodiment, the fiber has a largest circular diameter of 40 to 45 micrometers. Further, no restriction is placed on the cross-sectional shape of the fiber, providing the desirable properties such as electrochromic behavior, flexibility, and/or stretchability are not adversely affected. For example, the fiber can have a cross-sectional shape of a circle, ellipse, square, rectangle, or irregular shape.

The electrically conductive fibers (which as used herein include non-electrically conductive fibers rendered electrically conductive) are coated with an electrochromic material as described in further detail below to provide an electrically conductive, electrochromic fiber. The thickness of the electrically conductive and electrochromic layer will depend on factors such as the type of fiber, the type of electrolyte, the type of electrically conductive and electrochromic material, the device configuration, performance requirements, and like considerations, and can be readily determined by one of ordinary skill in the art without undue experimentation using the guidance herein. In one embodiment, the electrically conductive and electrochromic layer has a thickness of 0.1 to 10 micrometers, more specifically 0.1 to 6 micrometers, and even more specifically 3 to 6 micrometers.

The electrically conductive, electrochromic fiber can be used in the form of a single fiber, a yarn, or a fabric. A “yarn” as used herein is a multi-fiber thread formed from two or more of the electrically conductive, electrochromic fibers by a variety of means, including but not limited to spinning, braiding, knitting, crocheting, knotting, pressing, and plying. For convenience in later discussion, the term “electrochromic fiber” is used to refer to the electrically conductive, electrochromic fibers and yarns. It is to be understood that this term encompasses electrically conductive fibers coated with an electrochromic material; non-electrically conductive fibers that have been rendered electrically conductive and coated with an electrochromic material; and yarns comprising one or more of the foregoing types of fibers. Electrically conductive, electrochromic yarns can be used in place of or in addition to the electrically conductive, electrochromic fibers. Further, the electrochromic fibers can be used in the manufacture of a fabric. The fabric can be woven (e.g., a mesh, twill, satin, basket, leno or mock leno weave) or nonwoven (e.g., a felt, wherein the fibers are entangled).

Electrically conductive fibers formed from non-conductive fibers that have been rendered electrically conductive can also be used. In one embodiment, a nonconductive fiber is inkjet coated with a layer of a conductive material. Exemplary stretchable nonconductive fibers include those known for use in the manufacture of fabrics, including polyurethane (spandex), and blends of polyurethane (spandex) and an additional synthetic organic polymers (e.g., poly(amide) (nylon), poly(ethylene), poly(ester), poly(acrylic), poly(lactide), and the like) or natural materials (e.g., cotton, silk, and wool). Specific fibers include spandex fiber.

In another embodiment, fabrics prepared from a combination of stretchable fibers (e.g., polyurethane (spandex)) and other fibers (e.g. synthetic organic polymers or natural materials) can be used as long as the overall fabric is stretchable.

The nonconductive fiber can be coated with a conductive material (e.g. conductive polymer or conductive polymer precursor discussed herein) to render the fiber conductive. The coated fibers can be used as a fiber, or at least two coated fibers can be woven, knitted, crocheted, knotted, pressed, or plied to form a multi-filament fiber. It is also possible to have multiple nonconductive fibers formed into a yarn, and then coated with a conductive material. This construction can be used as a fiber, or be woven, knitted, crocheted, knotted, pressed, or plied to form a multi-filament fiber.

In one embodiment, any of the exemplary non-conductive fibers disclosed herein can be inkjet coated with an electrically conductive polymer, for example conjugated polymers such as poly(thiophene), poly(pyrrole), poly(aniline), poly(acetylene), poly(p-phenylenevinylene) (PPV), PEDOT-PSS, and the like, or a polymer precursor. In a specific embodiment, a flexible, elastic fiber is coated with an electrically conductive material such as PEDOT-PSS, sulfonated polythieno[3,4-b]thiophene polystyrenesulfonate, the various poly(aniline)s (e.g., those sold by Enthone under the trade name ORMECON), and the like; or an electrically conductive polymer precursor. In a specific embodiment, a nylon or spandex fiber is coated with PEDOT-PSS.

In a similar embodiment, a fabric made from any of the exemplary non-conductive fibers can be coated or impregnated with an electrically conductive polymer or electrically conductive polymer precursor.

Reviews on the various categories of electrochromic polymers have been published. (See for example, N. Rowley and R. Mortimer, “New Electrochromic Materials”, Science Progress (2002), 85 (3), 243-262 and “Electrochromic Materials”, in Proceedings of the Electrochemical Society, K. Ho, C. Greenberg, D. MacArthur, eds., Volume 96-23, 1997 among others). Electrochromic organic polymers are particularly useful, and have been described, for example, in the “Handbook of Conducting Polymers,” 3^{rd} Ed. By Skotheim and Reynolds, Chs. 1-5, 9, 10, 11, 20. Desirable properties for the electrochromic polymer include a high degree of transparency in the visible color region in the “off” state (non-reduced or non-oxidized states, high absorption in visible spectral region upon electroreduction or electrooxidation (“on” state) (or in the case of multi-colored polymers, a high contrast between colored states), low electrochemical potential for reduction/oxidation, high stability in the “on” or “off” state (bi-stable), strong adsorption to the conductive fiber, color tunability by synthetic variation of the electrochromic precursor, low solubility of the electrochromic materials in common solvents, and low toxicity. Desirable electrochromic materials are those that undergo the highest contrast change upon oxidation or reduction, that is, from a colorless to a highly colored state, from a colored state to a colorless one, or from one colored state to another colored state upon oxidation and reduction.

The electrochromic layer can be formed by direct inkjet coating of the electrochromic material, or by methods such as in situ polymerization of an inkjetted precursor material. In one embodiment the electrochromic material is a polymer formed by chemical or electrochemical oxidative polymerization of an inkjetted electrochromic polymer precursor comprising a functional group selected from pyrrole (1-aza-2,4-cyclopentadiene), thiophene, aniline, furan, carbazole, azulene, indole, bipyridine, diazapyrene, perylene, naphthalene, phenothiazine, triarylamine, substituted phenylendiamine, benzothiadiazole, ferrocene, and the derivatives of the foregoing compounds. The chemical or electrochemical polymerization of precursors can be performed after disposing the electrochromic precursor onto the conductive fiber or the conductive fabric via an inkjetting process.

The electrochromic precursor can be monomeric (in the case of electrodeposition) or polymeric, and can be selected from cathodically coloring materials, anodically coloring materials, or a combination thereof. In particular, the electrochromic precursor is a polymer or oligomer that can undergo further chain growth and/or crosslinking to produce the electrochromic material adheringly disposed on a substrate. “Polymerizing” includes chain growth reactions and/or crosslinking reactions to form the electrochromic material from an electrochromic precursor.
Cathodically coloring materials have a band gap (E_{g}) less than or equal to 2.0 eV in the neutral state. A cathodically coloring material changes color when oxidized (p-doped). The change in visible color can be from colored in the neutral state to colorless in the oxidized state, or from one color in the neutral state to a different color in the oxidized state. Cathodically coloring materials include, but are not limited to, polymers derived from a 3,4-alkylenedioxyheterocycle such as an alkylenedioxypyrrole, alkylenedioxythiophene or alkylenedioxyfuran. These further include poly(3,4-alkylenedioxyheterocycle)s comprising a bridge-alkyl substituted poly(3,4-alkylenedioxythiophene), such as poly(3,4-(2,2-dimethylpropylene)dioxythiophene) (PProDOT-(Me)₂, poly(3,4-(2,2-dihexylpropylene)dioxythiophene) PProDOT-(hexyl)₂, or poly(3,4-(2,2-bis(2-ethylhexyl)propylene)dioxythiophene) PProDOT-(ethylhexyl)₂. Herein, “colored” means the material absorbs one or more radiation wavelengths in the visible region (400 nm to 700 nm) in sufficient quantity that the reflected or transmitted visible light by the material is visually detectable to the human eye as a color (red, green, blue or a combination thereof).

An anodically coloring material has a band gap E_{g} greater than 3.0 eV in its neutral state. An anodically coloring material changes color when reduced (n-doped). The material can be colored in the neutral state and colorless in reduced state, or have one color in the neutral state and a different color in the reduced state. An anodically coloring material can also comprise a poly(3,4-alkylenedioxyheterocycle) derived from an alkylenedioxyheterocycle such as alkylenedioxypyrrole, alkylenedioxythiophene or alkylenedioxyfuran. Exemplary anodically coloring poly(3,4-alkylenedioxyheterocycle)s comprise an N-alkyl substituted poly(3,4-alkylenedioxypyrrole), such as poly(N-propyl-3,4-propylenedioxypyrrole) N—Pr PProDOP, poly(N-Gly-3,4-propylenedioxypyrrole) N-Gly PProDOP, where N-Gly designates a glycinamide adduct of pyrrole group, or N-propane sulfonated PProDOP (PProDOP-NPrS).

Electrochromic polymers also include, for example, poly(3,4-ethylenedioxythiophene) (PEDOT), poly(3,4-propylenedioxythiophene) (PProDOT), and poly(1,4-bis[(3,4-ethylenedioxy)thien-2-yl)]-2,5-didodecyloxybenzene) P(BEDOT-B).

Specific electrochromic precursors include those of formula (I):

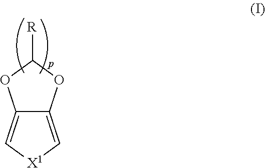

wherein X¹ is NH, S, O, or N-G¹ wherein G¹ is a straight, branched chain, or cyclic, saturated, unsaturated, or aromatic group having from 1 to 20 carbon atoms and optionally 1 to 3 heteroatoms selected from S, O, Si, and N, and optionally substituted with carboxyl, amino, phosphoryl, sulfonate, halogen, or straight, branched chain, or cyclic, saturated, unsaturated, or aromatic group having from 1 to 6 carbon atoms and optionally 1 to 3 heteroatoms selected from S, O, Si, and N (for example phenyl, substituted phenyl, or propyl sulfonate); R is H, an O-alkyl group comprising 1 to 20 carbons, or an alkyl group comprising 1 to 20 carbons.

Other electrochromic precursors include those of formula (II):

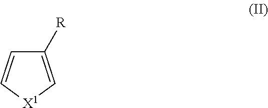

wherein X¹ and R have been previously defined above.

Other electrochromic precursors include those of formula (III):

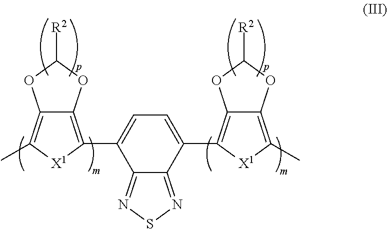

wherein X¹ is as previously defined, each instance of R² is independently H, an O-alkyl group comprising from 1 to 20 carbons, or an alkyl group comprising from 1 to 20 carbons, p is an integer from 1 to 20, and m is an integer from 1 to 100.

Other electrochromic precursors include those of formula (IV):

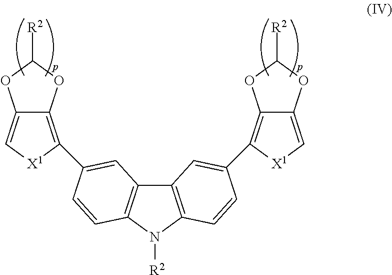

wherein each instance of X¹ independently is as previously defined, each instance of R² independently is as previously defined, and p is an integer from 1 to 20.

Other electrochromic precursors include those of formula (V):

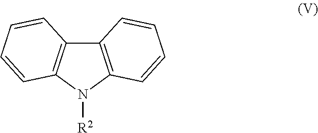

R² is as previously defined.

Other electrochromic precursors include those of formula (VI):

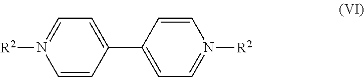

wherein each instance of R² independently is as previously defined.

Other electrochromic polymer precursors have the general formulas (VII) and (VIII):

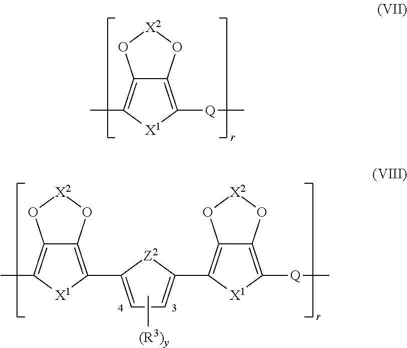

wherein r is an integer greater than 0; y is an integer from 0 to 2; Z¹ and Z² are independently —O—, —NH—, or —S—; X² is an alkylene group comprising 1 to 20 carbons; Q is a silylene group, for example —Si(R⁴)₂— or —Si(R⁴)₂—O—Si(R⁴)₂—, wherein R⁴ is an alkyl group comprising 1 to 20 carbons, for example methyl, ethyl, propyl, isopropyl, n-butyl, n-pentyl, n-hexyl, n-heptyl, or n-octyl; and R³ is an alkyl or aryl group comprising 1 to 20 carbons attached at the 3 and/or 4 position (shown) of the five-membered ring containing Z². Exemplary R³ include methyl, ethyl, propyl, isopropyl, n-butyl, n-pentyl, n-hexyl, n-heptyl, n-octyl, phenyl, n-butylthio, n-octylthio, phenylthio, and methoxyphenyl.

In one embodiment, r is an integer from 1 to 1000, y is 0, X² is ethylene (—CH₂CH₂—), Z¹ and Z² are both sulfur, Q is —Si(R⁴)₂—, and R⁴ is n-octyl. This 2,5-bis[(3,4-ethylenedioxy)thien-2-yl]-thiophene (BEDOT-T) silylene precursor polymer can be formed by the nickel-catalyzed coupling of 3,4-ethylenedioxythiophene with dibromothiophene, to form BEDOT-T, followed by deprotonation of BEDOT-T using n-BuLi to form a dianion of BEDOT-T, and reacting the dianion with dichlorodioctylsilane to form the BEDOT-T silylene precursor polymer. The weight average molecular weight of the BEDOT-T silylene precursor polymer can be 1000 to 100,000 g/mole, more specifically 1,000 to 10,000 g/mole.

In another specific embodiment, r is an integer from 1 to 1000, y is 0, X² is 2,2-dimethylpropylene (—CH₂C(CH₃)₂CH₂—), Z¹ and Z² are both sulfur, Q is —Si(R⁴)₂—O—Si(R⁴)₂—, and R⁴ is methyl. This ProDOT-Me₂ silylene precursor polymer can be prepared by transesterification of 3,4-dimethoxythiophene with 2,2-dimethyl-1,3-propanediol using para-toluene sulfonic acid (PTSA) or dodecylbenzene sulfonic acid (DBSA) as catalysts in anhydrous toluene to form ProDOT-Me₂, deprotonating the ProDOT-Me₂ using 2 equivalents of n-BuLi to form the dilithium dianion, and reacting the dilithium dianion with dichlorotetramethylsiloxane to form the ProDOT-Me₂ silylene precursor polymer. The weight average molecular weight of the ProDOT-Me₂ silylene precursor polymer can be 1000 to 100,000 g/mole, more specifically 1,000 to 5000 g/mole.

In addition to the heterocyclic ring systems shown in the precursors of formulas (VII) and (VIII), other aromatic heterocycle groups, e.g., those of formulas (I)-(V), can also be synthesized with silylene of formula Q. Additional electrochromic precursors are described, for example, in U.S. Pat. No. 7,321,012, U.S. Published Application No. 2007-0089845, WO2007/008978, and WO2007/008977.

A variety of different techniques can be used to apply electrochromic materials or electrochromic polymer precursor mixture, to the stretchable fibers or to the stretchable fabrics, for example spray coating, inkjet coating, dip coating, electrostatic spinning, gravure coating methods, extrusion coating, stamping, screen printing, rotary press, and similar printing techniques can be used. In one embodiment, inkjet printing is employed. The stretchable fibers and stretchable fabrics can be electrically conductive or non-conductive.

Polymerizing the electrochromic polymer precursor can be accomplished electrochemically (in situ or ex situ), chemically, thermally, or by radiative crosslinking. In particular, the electrochromic precursor is polymerized electrochemically. For example, the fiber or fabric, once coated with the electrochromic polymer precursor, can be converted to an electrochromic electrode in situ (inside an assembled device type) by applying an oxidative potential across the device. The electrochromic polymer precursor irreversibly converts to the electrochromic polymer and can be switched as normal, with a moderate reduction in optical contrast. In another embodiment, the coated electrically conductive fiber or fabric is converted ex situ. The coated electrically conductive fiber or fabric is immersed in a 0.1 M electrolyte solution (typically lithium triflate in acetonitrile, though many other salts and solvents can be used) and the appropriate voltage is applied via a three-electrode cell (using a Pt counter electrode and a calibrated non-aqueous Ag/Ag⁺ reference electrode) for a given period of time, depending on the desired thickness of the electrochromic precursor layer. In this manner, an insoluble electrochromic layer of material is disposed on the electrically conductive fiber or fabric, which can then be coated with an electrolyte (e.g. stretchable polymeric electrolyte) to form an electrochromic electrode.

In preparing the electrochromic device, the stretchable electrolytes of U.S. Ser. No. 61/448,293 can be used.

The stretchable electrolyte is a stretchable polymeric electrolyte generally comprising a stretchable polymeric material and a salt to provide ionic conductivity. The stretchable polymeric electrolyte is transparent and elastic, and is capable of being stretched, flexed and bended. Specifically the stretchable polymeric electrolyte has an elongation at break of greater than about 10%, specifically greater than about 20%, still more specifically greater than about 100%, and yet still more specifically greater than about 200%.

The salt used to prepare the stretchable polymeric electrolyte can be an ionic liquid salt. Ionic liquids are a group of salts with such low melting points that they remain in the molten state at room temperature. Ionic liquids typically used in polymer electrolytes have nitrogen-containing organic cations and bulky inorganic anions. The properties which make ionic liquids useful for electrolytes include very low vapor pressure (less evaporation as solvent and higher stability), non-flammable (more thermally stable), wide electrochemical window (wide range for electrochromic device to perform), and high ionic conductivity (most essential property needed for electrolytes). Ionic salts can comprise an anion (e.g. halide, tetrafluoroborate, hexafluorophosphate, bistriflimide, triflate, tosylate, formate, alkylsulfate, alkylphosphate, glycolate, and the like); and a bulky organic cation (e.g., 1-alkyl-3-methylimidazolium, 1-alkylpyridinium, N-methyl-N-alkylpyrrolidinium, and the like). Exemplary ionic liquids for use in the polymeric electrolyte include 1-butyl-3-methylimidazolium hexafluorophosphate ((BMIM)PF₆), 1-ethyl-3-methylimidazolium hexafluorophosphate, pyridinium chloride (C₅H₆NCl) and other ionic liquids with similar structures.

Other suitable salts for use in the polymeric electrolyte include an alkali metal ion salt of Li, Na, or K. Exemplary salts, where M represents an alkali metal ion, include MClO₄, MPF₆, MBF₄, MAsF₆, MSbF₆, MCF₃SO₃, MCF₃CO₂, M₂C₂F₄(SO₃)₂, MN(CF₃SO₂)₂, MN(C₂F₅SO₂)₂, MC(CF₃SO₂)₃, MCₙF₂ₙ₊₁SO₃ (2≦n≦3), MN(RfOSO₂)₂ (wherein Rf is a fluoroalkyl group), MOH, or a combination thereof.

The stretchable polymeric material for the stretchable polymeric electrolyte is generally a thermoplastic polyurethane, thermoplastic polyurea, a polyethylene oxide, a crosslinked polyethylene oxide, or a combination thereof. The thermoplastic polyurethane/urea used as the polymeric electrolyte is not chemically crosslinked. The thermoplastic polyurethane/urea typically has a large elongation to break (about 400% to about 800%), and returns quickly and almost completely to the original length after release of deformation stress in certain ranges.

In one embodiment, the stretchable polymeric electrolyte is prepared from a stretchable polymeric electrolyte premix comprising a thermoplastic polyurethane prepolymer, a thermoplastic polyurea prepolymer, or a combination thereof; a curative, a salt, and an organic solvent. In other embodiments, the stretchable polymeric electrolyte is prepared directly from monomers.

In another embodiment, the stretchable polymeric electrolyte is prepared from a polyethylene oxide or a crosslinkable polyethylene oxide.

The salt for use in the stretchable polymeric electrolyte premix can be one or more of the salts described above for use in the stretchable polymeric electrolyte.

The solvent used to prepare the polymeric electrolyte premix is generally any organic solvent which can dissolve the thermoplastic polyurethane/polyurea prepolymer and salt. Because the components of premix, have either a very small domain size or are completely solubilized in a single phase they are optically transparent in the visible wavelength range. Exemplary solvents include high boiling, polar organic solvents and halogenated organic solvents such as N,N-dimethylformamide (DMF), dimethylacetamide, toluene, xylene, tetraglyme, low molecular weight (MW<800) liquid polyethylene oxides, and the like, or combinations thereof.

The thermoplastic polyurethane prepolymer is generally prepared from the reaction between at least one macropolyol, specifically a macrodiol, and at least one polyisocyanate, specifically a diisocyanate. The thermoplastic polyurea prepolymer is generally prepared from the reaction between at least one macropolyamine, specifically a macrodiamine, and at least one polyisocyanate, specifically a diisocyanate. Various combinations of macropolyol, macropolyamine, and polyisocyanate can be made which will impart the prepolymer, and thus the resulting polymer, with different properties.

A generalized formulation for the polyurethane/urea prepolymer endcapped with a group (“E”) having an isocyanate group is according to formula (IX):

OCN-E-[-C(═O)—NH-G-NH—C(═O)—X-L-X-]ₙ-E-NCO (IX)

wherein G is an aliphatic or aromatic group having up to about 30 carbons, specifically a cyclic aliphatic or aromatic group; each instance of X is independently O or NH; L is a polyether or polyester. The percentage of the NCO functional group of the prepolymer can be about 0.5 to about 6%, specifically about 2 to about 4.5, and more specifically about 3 to about 3.5%.

The polyisocyanate for use to prepare the thermoplastic polyurethane/urea or thermoplastic polyurethane/urea prepolymer can include aliphatic or aromatic polyisocyanates having up to 30 carbons and at least 2 isocyanate groups, specifically 2 isocyanate groups.

The aromatic polyisocyanate can have up to about 30 carbons and 2, 3, 4 or more isocyanate groups. In one embodiment, the aromatic polyisocyanate is according to formula (X)

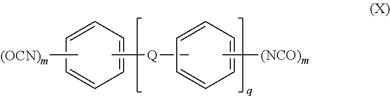

wherein q is 0 or 1; each instance of m is independently 1 or 2, and Q is a bond, C₁-C₆ alkyl, C₁-C₆ haloalkyl, C₁-C₃ alkyl-O—C₁-C₃ alkyl, C₁-C₃ alkyl-S—C₁-C₃ alkyl, C₁-C₃ alkyl-S(═O)—C₁-C₃ alkyl, C₁-C₃ alkyl-S(═O)₂—C₁-C₃ alkyl, O, S, S(═O), S(═O)₂, or C(═O); specifically C₁-C₃ alkyl, C(CH₃)₂, CH₂, CH₂CH₂, O, C(CF₃)₂, CH₂OCH₂, S(═O), S(═O)₂, C(═O), CH₂S(═O)CH₂, or CH₂S(═O)₂CH₂.

Exemplary aromatic diisocyanates include phenylene diisocyanate including isomer mixtures or single isomers; 4,4′-diphenylmethane diisocyanate; 2,4′-diphenylmethane diisocyanate; 2,2′-diphenylmethane diisocyanate; toluylene diisocyanate including isomer mixtures or single isomers; 2,4-toluylene diisocyanate; 2,6-toluylene diisocyanate; xylylene diisocyanate; 1,5-naphthylene diisocyanate; and 3,3′-dichloro-4,4′-diphenylmethane diisocyanate; and the like. In one embodiment, the diisocyanate is 4,4′-diphenylmethane diisocyanate (“MDI”).

The aliphatic or alicyclic polyisocyanate can have up to about 30 carbons and 2, 3, 4 or more isocyanate groups. Exemplary aliphatic or alicyclic diisocyanates include hexamethylene diisocyanate, isophorone diisocyanate, 4,4′-dicyclohexylmethane diisocyanate and hydrogenated xylylene diisocyanate; and the like. One or more of the aromatic, aliphatic, and alicyclic polyisocyanates can be used to prepare the prepolymer or polymer.

As long as the stretchabililty of the ultimate polyurethane/polyurea is not unduly affected, small amounts of tri-functional or higher poly-functional polyisocyanates, such as triphenylmethane triisocyanate, can be included with the diisocyanate.

The macropolyol used to prepare the thermoplastic polyurethane prepolymer by reaction with the polyisocyanate can include a compound having hydroxyl number of about 30 to about 350, which is capable of reacting with an isocyanate group.

The macropolyol or macropolyamine used to prepare the thermoplastic polyurethane/urea prepolymer by reaction with the polyisocyanate can include a compound having a number average molecular weight of about 300 to about 2500, specifically about 500 to about 2000, and more specifically about 750 to about 1500. Suitable macropolyol and macropolyamine include macroglycols, polyether diols, polyester diols, polyether diamines, and polyester diamines, and the like, or combinations thereof.

In the reaction to prepare the prepolymer, the ratio of macrodiol to diisocyanate is generally about 1:1; and the ratio of macrodiamine to diisocyanate is generally about 1:1.

A catalyst may be employed to promote the reaction between the polyisocyanate and the macropolyol, macropolyamine, or both. Exemplary suitable catalysts include bismuth catalyst; zinc octoate; tin catalysts, such as di-butyltin dilaurate, di-butyltin diacetate, tin(II) chloride, tin(IV) chloride, di-butyltin dimethoxide, dimethyl-bis[(1-oxonedecyl)oxy]stannane, di-n-octyltin bis-isooctyl mercaptoacetate; amine catalysts, such as triethylenediamine, triethylamine, and tributylamine; organic amine catalysts, or a combination thereof. The catalyst is added in an amount sufficient to catalyze the reaction of the components in the reactive mixture. In one embodiment, the catalyst is present in an amount of from 0.001 wt % to 5 wt %, based on the total weight of the starting material.

An exemplary polyurethane prepolymer is Duracast™ E900 commercially available from Chemtura.

The thermoplastic polyurethane prepolymer, thermoplastic polyurea prepolymer, or both are combined with a chain extender (“curative” e.g. a diol or a diamine) to allow for a chain extension reaction to form the thermoplastic polyurethane or thermoplastic polyurea.

The chain extender used in combination with the thermoplastic polyurethane/urea prepolymer to prepare the thermoplastic polyurethane/urea can include a compound having a number average molecular weight of not more than 300 and having two or more active hydrogen atoms capable of reacting with an isocyanate group. Suitable compounds include diols such as ethylene glycol, propylene glycol, 1,4-butanediol, 1,6-hexanediol, 1,4-bis(β-hydroxyethoxy)benzene, 1,4-cyclohexanedimethanol, 3-methyl-1,5-pentanediol, bis(β-hydroxyethyl)terephthalate, xylylene glycol; diamines such as hydrazine, ethylenediamine, propylenediamine, isophoronediamine, piperazine, piperazine derivatives, phenylenediamine, toluylenediamine, xylylenediamine, adipic acid dihydrazide and isophthalic acid dihydrazide; aminoalcohols such as aminoethyl alcohol and aminopropyl alcohol; and the like; or combinations thereof. A specific diol includes an aliphatic diol having 2 to 10 carbon atoms.

An exemplary chain extension curative is Duracure™ C3 commercially available from Chemtura.

Polymeric electrolytes with different stretching ability and conductivity could be achieved by varying the polyurethane/urea prepolymer composition, and varying the salt used.

In an exemplary process to prepare the stretchable polymeric electrolyte for application onto a substrate, a polymeric electrolyte premix containing a polyurethane prepolymer, a polyurea prepolymer, or a combination thereof; and a curative such as a diol or diamine for chain extension reaction is dissolved in a solvent (discussed above). The resulting mixture is combined with a salt, such as an ionic liquid to form the polymeric electrolyte premix.

The polymeric electrolyte premix can be applied to a substrate, specifically a stretchable, porous substrate, to coat, imbibe, or impregnate the substrate. The polymeric electrolyte premix can be applied using coating processes known in the art, such as drop casting, dip coating, spray coating, ink jet coating, electrostatic spinning, gravure coating methods, extrusion coating, stamping, screen printing, rotary press, and similar printing techniques, and the like. The solvent is then allowed to evaporate and the prepolymer is chain extended via the curative to form a transparent, flexible and stretchable polymeric electrolyte which coats, impregnates, or coats and impregnates the substrate.

The thickness or amount of the stretchable polymeric electrolyte layer on the stretchable substrate will depend on factors such as the type of electrochromic fiber, the type of electrolyte, the device configuration, performance requirements, and like considerations, and can be readily determined by one of ordinary skill in the art without undue experimentation using the guidance herein. In one embodiment, the stretchable polymeric electrolyte layer has a thickness of 10 to 500 micrometers, more specifically 10 to 200 micrometers, 20 to 150 micrometers, or 50 to 100 micrometers.

Devices such as spandex fiber or fabric coated or impregnated with a conducting polymer and coated or impregnated with the transparent, stretchable polymeric electrolyte are able to switch between two color states before, during, and after stretching of the device.

In one embodiment, a method of forming a stretchable electrochromic fiber or fabric comprises inkjetting an electrically conductive, electrochromic material onto a non-electrically conductive, stretchable fiber or fabric to form a coated fiber or fabric. The method further comprises disposing a stretchable polymeric electrolyte premix on the coated fiber or fabric to form a stretchable, electrochromic fiber or fabric. A stretchable, electrochromic fabric can be formed from a plurality of the stretchable, electrochromic fibers by weaving or entangling the plurality.

In a specific embodiment, inkjetting the electrochromic material comprises inkjetting a monomeric electrochromic precursor, and polymerizing the electrochromic precursor to form a polymeric electrochromic layer on the surface of the non-electrically conductive, stretchable fiber or fabric.

Articles comprising the stretchable electrochromic fibers, fabrics, and devices which comprise a stretchable polymeric electrolyte include garments. The electrochromic device can be the entire garment or a portion of the garment. The electrochromic device can further be an integral part of the garment or a detachable portion of the garment.

The electrochromic devices can be operated in a reflective mode, and therefore do not require a transparent electrode or transparent conductive substrate. The devices also exhibit good switching times, reversibly changing color in response to an applied electrical potential in less than one second. The color change can differ depending on the polarity of the applied field.

In one embodiment, an electrode in an electrochromic device comprises a stretchable electrochromic substrate coated with a stretchable polymeric electrolyte as disclosed herein. The stretchable electrochromic substrate can be prepared from a non-conductive material (e.g. spandex) and an electrically conductive and electrochromic layer (e.g. PEDOT-PSS) inkjetted thereon.

Electrochromic devices can be prepared comprising one or more of the electrochromic fiber electrodes. Each fiber electrode can be independently electronically addressable and each can display the same or a different visible color in response to an applied electrical potential.

Electrically conductive fabrics can be obtained from nonconductive fabrics that are subsequently treated to provide conductivity. Such nonconductive fabrics can comprise fibers or yarns of any of the exemplary synthetic and natural nonconductive materials described above. A specific exemplary flexible and elastic nonconductive woven cloth base is spandex, sold under the trade name LYCRA® by Dupont De Nemours. Spandex is a polyurethane containing segments of polyester or polyether polyols that allow the fiber to stretch up to 600% and then recover to its original shape. The fabric can be selected to be both flexible and elastic. For example a flexible, elastic conductive fabric can be obtained by weaving or warp knitting the fabric from nylon and/or spandex fibers or yarns, and then inkjet printed with a conducting material. The resulting fabrics can be both flexible and elastic. The fabrics are not only more flexible than fabrics formed from metal fibers, but also tend to be lighter and more resistant to oxidation. Because the fibers or yarns can be knit tightly, the electrical conductivity of the fabric can be maintained despite a partial loss of the conductive coating on particular threads, whereas in metal fiber conductive fabrics, the fabric may lose operability after a break in one of the fibers, particularly if the fibers are spaced far apart. Stretch fabrics based on metallized nylons are commercially available from Shieldex Trading, USA.

In one embodiment, the flexible, electrically conductive woven and nonwoven fabrics can further be produced by impregnating nonconductive woven or nonwoven fabrics with electrically conductive particulate fillers. The electrically conductive particles can comprise any of the electrically conductive metals, e.g., powdered stainless steel or organic polymers as described above, or other conductive particles such as ITO, carbon nanotubes, carbon black, graphene, and the like. The size, shape, and concentration of these particles can be varied to vary the conductivity of the fabric. In a specific embodiment, a nonconductive woven or nonwoven fabric is treated with a bonding agent (e.g., an organic polymer precursor or organic polymer, such a poly(acrylate)) containing the electrically conductive particles. Nonwoven polyester stretch fabrics of this type are commercially available from Krempel Group.

The conductive fabric (or nonconductive fabric that has been rendered conductive) can be inkjet coated with an electrochromic material (described above) to produce an electrochromic fabric electrode for an electrochromic device. The electrochromic fabric electrode can also comprises a layer of stretchable polymeric electrolyte.

In one embodiment, a single electrochromic material is inkjetted to form the electrochromic fabric electrode. In another embodiment, two or more electrochromic materials are inkjetted on the conductive fabric imagewise to form an electrochromic fabric electrode that displays a colored image when subjected to an electrical potential. The colored image can comprise one or more visible colors.

The disclosed processes can be used to prepare a variety of fabric electrochromic device architectures with high resolution patterning. In one embodiment, a flexible, stretchable conductive spandex substrate is used. The devices, due to their ability to fit to shape and to stretch and contort, are suitable for biomimicry, adaptive camouflage, wearable displays, and fashion related applications. Use of the high-resolution patterning is suitable for electrochromic materials on textiles as conductor as well as active color-change materials. Color changes can be localized within the cross junction on spandex substrates due to the relatively low conductivity of the substrate, which can serve as one of the advantages for device fabrication in terms of pixilation, opening up a wide range of possibilities for the display industry.

The following illustrative examples are provided to further describe how to make and use the polymers and are not intended to limit the scope of the claimed invention.

### EXAMPLES

### Example 1

### Formation of a Fabric Electrochromic Device by Inkjet Printing Process

ORGACON© PEDOT-PSS was a sample provided by Agfa and used as received alone or with additives as inks. Dimethyl sulfoxide (DMSO), dimethylformamide (DMF), ethylene glycol (EG) were purchased from Sigma-Aldrich and used without further purification. Stainless steel mesh was provided by TITK (Germany). The fabric is a commercially available spandex containing approximately 50% nylon (Lubrizol), with a thread count of 5882 and a denier of 70. Poly(bis[3,4-ethylenedioxythiophene]-thiophene-dioctylsilane) (PBEDOT-T-Si[Octyl]₂) was synthesized according to previous publications (Invernale, M. A. Ding, Y. Mamangun, D. M. D. Yavuz, M. S.; Sotzing, G. A. Advanced materials. 2010, 22, 1379-82 and Invernale, M. a; Ding, Y.; Sotzing, G. a ACS applied materials & interfaces. 2010, 2, 296-300).

PEDOT-PSS ink was formulated as described in Example 2. The drop spacing was set to be 40 μm. Fabric substrates were stretched 20% during printing and relaxed to their original length afterwards. Dimatix 2800 material inkjetter and corresponding cartridges are products of FUJI FILM, DIMATIX Inc. (Santa Clara, USA).

Fabric devices were assembled by inkjet printing PBEDOT-T-Si[Octyl]₂ solution onto the fabric substrates. Each drop from the cartridge nozzle contains 10 pL of the ink solution where the quick absorbance and fast evaporation of the solvent allows for well-defined lines and corners to be printed on the fabric substrates. The printed PBEDOT-T-Si[Octyl]₂ is then converted by exposing to ferric chloride ACN solution or electrochemically in 0.1M LITRIF/ACN electrolyte bath. The substrate was then dried and encased with another piece of conductive fabric in a colorless gel electrolyte. The gel electrolyte is composed of 5 g of propylene carbonate, 5 g of poly(ethylene glycol)diacrylate (Mn=700 g/mol), 1 g of trifluoromethanesulfonate, 17.5 mg of -2,2-Dimethoxy-2-phenyl-acetophenone (DMPAP) and crosslined by UV exposure. All chemicals were purchased from Sigma-Aldrich and used as received. All color coordinates were determined by Spectrascan PR670 (PhotoResearch). Conductivity measurement were done by the four-probe approach, the thickness of the inkjet-printed PEDOT-PSS was estimated to be half of the fabric thickness (200 μm).

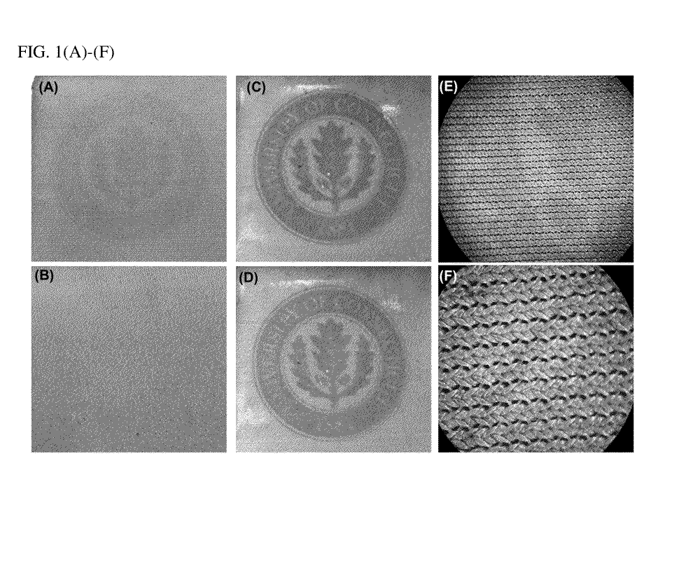

FIG. 1(A) shows a University of Connecticut (UCONN) logo inkjet-printed onto the spandex substrate, the precursor polymer (PBEDOT-T-Si[Octyl]₂) was chosen to be the active electrochromic material. Because of the small volume of the ink drops, the solvent evaporated before it could penetrate the textile matrix and therefore the back side of the fabric (FIG. 1(B)) remained pristine. After converted to its polymer form either chemically or electrochemically, the fabric was assembled into an electrochromic device and switched between a potential of ±3V. FIGS. 1 (C) and (D) show the assembled device in its reduced and oxidized states. The fine features of the pattern were all preserved in the printed logo. FIGS. 1(E) and (F) are microscopic pictures of the printed UCONN logo on spandex fabric in its neutral state. FIG. 1 (E) shows the leaf pattern and (F) shows the edge of part of the outmost circle in the logo. As can be seen in these images, the solution did not bleed out to the adjacent threads, giving a crisp and sharp image on the substrate.

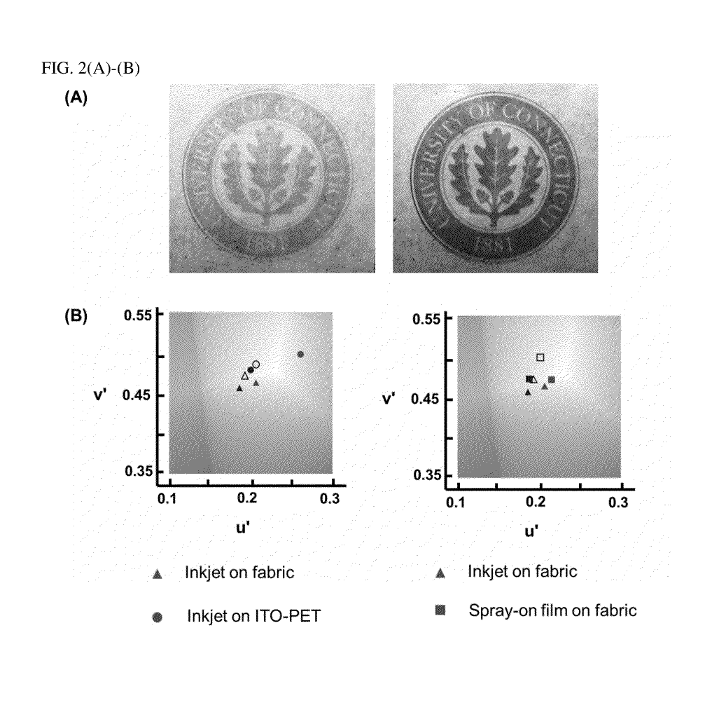

Color coordinates of the patterns in colored and bleached states are shown in FIGS. 2A and 2B. It was found that the blue shade of the base fabric shifted the color of the pattern into the blue region comparing to that on ITO-PET substrates. However, the difference between the spray-coated pattern and the inkjet-printed pattern was found to not be significant. The printed logo has a slight shift mainly due to the different morphology as well as less deposited material compared to spray-coating (not shown).

Color characterization was performed using a PhotoResearch PR-670 Colorimeter with a 10° standard observer angle and a measurement range of 360 nm to 860 nm in 1 nm intervals. A black box was used for all the color measurements while a D65 standard illuminant lamp was used as the light source of the system. MS-5× zoom lens with ⅛° aperture was used because of its ability of focusing on the individual threads of the woven textiles.

### Example 2

### Inkjet Patterning of Conductors onto Fabric Substrate

Precise patterning of the conductors can be done by inkjet-printing PEDOT-PSS dispersion onto the spandex fabric. It is widely known that additives such as surfactant, high-boiling point solvent and some small molecules (“dopants”) can significantly increase the conductivity of the PEDOT-PSS films. Various dopants were studied and it was found that dopants that work well for films do not necessarily do the same for PEDOT:PSS fabrics. For example, d-sorbitol, a widely used secondary dopant, does not significantly increase the conductivity of the soaked spandex. Calvert et al. reported ca. 20 S/cm conductivity of inkjet-printed PEDOT-PSS with DMSO and EG additive on PET mesh fabric. Adding DMSO, in our case, did not improve the conductivity of the spandex fabric. In fact, the conductivity decreased to one tenth of its original value (from 0.10 S/cm to 0.013 S/cm) after adding DMSO. Not wishing to be bound by theory, but the reason for this could be: (a). The morphology of the PEDOT-PSS on PET mesh (substrate in Calvert's study) is a film-like structure while our spandex is a knitted structure. The absorbing nature of the spandex fiber and the uneven surface make it unlikely to form a smooth continuous film as on glass substrates and therefore the additive which was good for film structure did not work for the fabric matrix. (b). EG is the actual component that improves the conductivity and this has been demonstrated by the increase of conductivity to 0.19 S/cm from adding 10% EG to the ink formulation, which is almost two times that of pristine PEDOT-PSS ink. See Table 1.

TABLE 1
Conductivity values of fabrics modified by PEDOT-PSS and
different additives.

| | Conductivity |
|---|---|
| Ink formulation | (S/cm) |
| PEDOT:PSS (soaked) | ~0.10 |
| PEDOT:PSS (inkjet w/o additive) | ~0.063 |
| PEDOT:PSS + 10% DMSO (inkjet) | ~0.013 |
| PEDOT:PSS + 10% Ethylene glycol (inkjet) | ~0.19 |
| PEDOT:PSS + 10% DMF (inkjet) | ~0.080 |
| PEDOT:PSS + 10% Ethylene glycol + 10% DMF | ~0.16 |
| (inkjet) | |

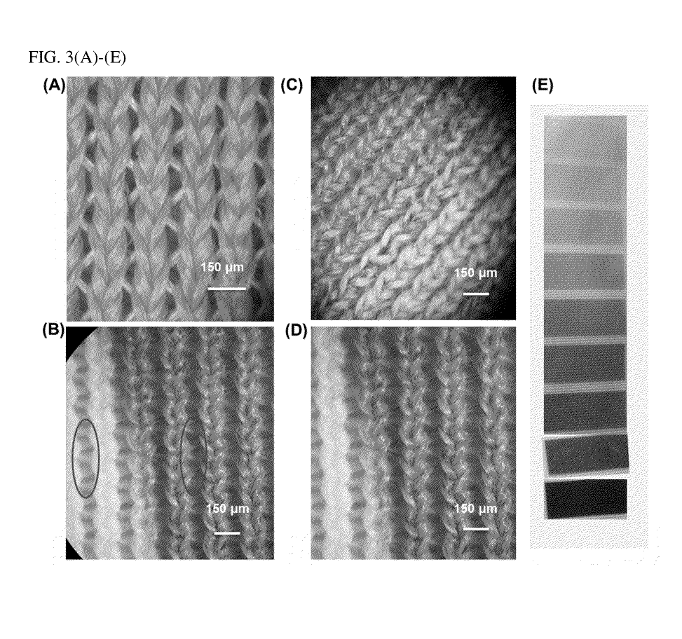

However, both pristine PEDOT-PSS ink and the EG containing ink faced adhesion problems. The fast drying process of small ink droplets limited the spreading of the ink and allowed the formation of narrow lines and defined patterns; it also prevented the solution from diffusion into the matrix because it tended to form layers of PEDOT:PSS sitting on top of the fabric surface. When subjected to external peel or abrasion, as shown in FIG. 3(C), the conductive coatings easily fell off the fabric surface and exposed the insulating base fabric. Adding 10% DMF into the ink formulation helped the ink solution to swell the fabric and penetrate into the threads. Because DMF is a good swelling solvent for polyurethane, which is the major component of spandex fabric, the solvent additive rendered better adhesion between the conductive coating and the base matrix. (FIG. 3(D)).

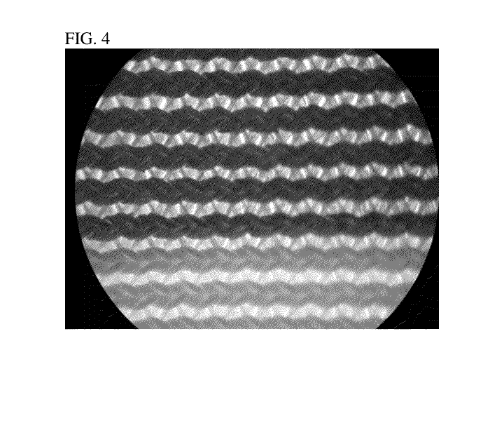

The conductivity of different ink formulations are listed in Table 1. Repeated deposition gives higher conductivity and darkens the color of the spandex fabric (FIG. 3(E)). Spandex was printed under a 20% stretch in order to deposit conductive ink onto the underlying layer of the woven structure between the threads as well (FIG. 3(B) red circles). Otherwise conductor particles would just accumulate on the surface of the top spandex layer and cannot form a continuous path throughout the fabric matrix. Such sample gives no reading when tested with the four-probe conductivity setup. When printed under stretching, underlay threads were exposed to ink too and help to complete the conducting path and enhance the performance (FIG. 4). However, because PEDOT-PSS particles were deposited in a 3-dimensional volume and are not continuous in the layer underneath, an average film thickness for the conductivity calculation was estimated: 200 μm (the diameter of the surface threads) was used for calculation in the study. Viscosity data are shown in Table 2. Viscosity of the ink can be adjusted to result in high-quality conductive patterns. An ink formulation viscosity of 10-20 cP provided high-quality conductive patterns. High resolution is difficult to achieve with too low a viscosity and the drops cannot blend with each other properly to form a continuous conductive path if the viscosity is too high.

TABLE 2

| Ink formulation | Viscosity (cP) |
|---|---|
| Precursor toluene solution (2 mg/ml) | 0.58 |
| PEDOT:PSS (inkjet w/o additive) | 5.49 |
| PEDOT:PSS + 10% Ethylene glycol | 6.00 |
| PEDOT:PSS = 10% Ethylene glycol + 10% DMF | 6.34 |

### Example 3

### Localization of Electrochromic Color Change and Pixilation

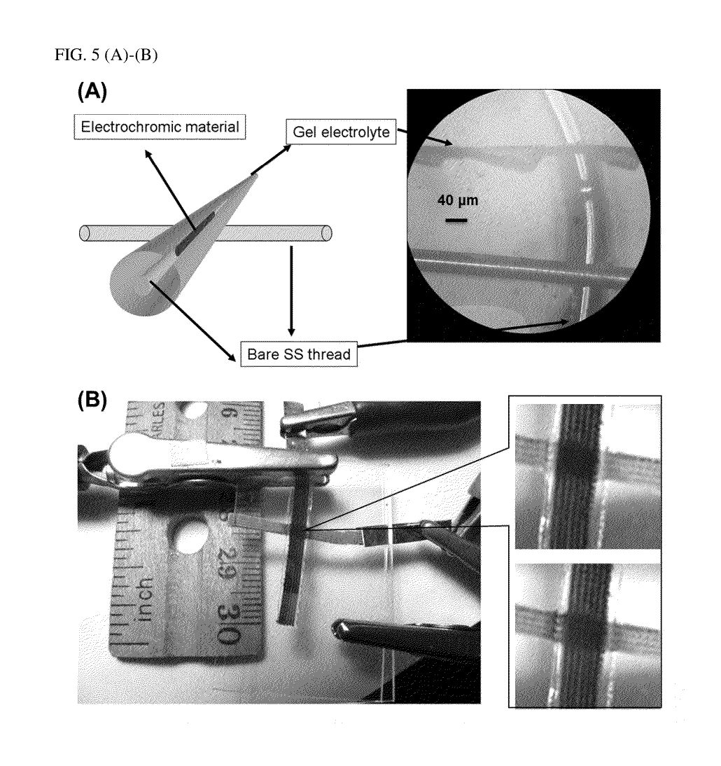

Electrochromic devices can been fused together by encasing or connecting the electrodes by the crosslinked gel. However, for an electrochromic device to function, the two pieces of electrodes do not necessarily have to be fused together. We have demonstrated, as shown in FIG. 5(B), as long as one piece of the electrode (e.g. the working electrode) is encased in the gel electrolyte the device can function properly just by pressing the two electrodes together. With this structure, it is possible that threads could function as electrodes. In which case, if only the working electrode threads are coated with electrolyte and the counter electrode threads are left bare, the flexibility as well as the comfort level of the electrochromic garments can be significantly enhanced for the users. The two electrodes can be pressed together by a tight weaving process for the electrochromic to function.

One of the interesting features of the PEDOT-PSS modified fabric is that due to its relatively low conductivity (0.1 S/cm comparing to ca. 9800 S/cm of stainless steel), the electrochemistry taking place on its surface can be localized in a certain region. As illustrated by FIG. 5, FIG. 5(A) shows a cross section setup by using two stainless steel threads, including one thread on top coated with electrochromic material and gel electrolyte and a bare stainless steel thread on the bottom as the counter electrode. When potentials are applied through the cross section, all the electrochromic materials along the top thread responded to the stimulus and switched to red. However, in a similar setup utilizing PEDOT-PSS spandex as the electrodes, the color change only propagated within a limited region. Only the materials within close range to the counter electrode switched from red to blue. Electrochromic materials further from the cross junction remained in their red state.

This localization of color change can lead to various applications and thus turn the relatively low conductivity of conductive fabrics into an advantage. By patterning the counter electrode, color change of the active material can be localized and form patterns even individual pixels. FIG. 62 is a schematic depiction of one of the many possibilities. In this example, the counter electrode is patterned to be only partially conductive by inkjet-printing PEDOT-PSS and the rest remain insulating. The working electrode coated with active material is in contact with such a patterned counter electrode without being connected to each other. Pressure triggered by normal body movement (e.g. bending the arm) or the wearer or other external stimuli can induce color switching localized to the vicinity of where the two conductive parts are in contact. Thus the patterning can be switched “on” and “off” without any trace on the top fabric piece. Furthermore, since there is no need to coat the bottom counter electrode with polymer electrolyte, the layer which is in direct contact with the skin still has the feel of normal textiles.

### Example 4

### Schematic of an Electrochromic Device Built on Woven Structure Substrates

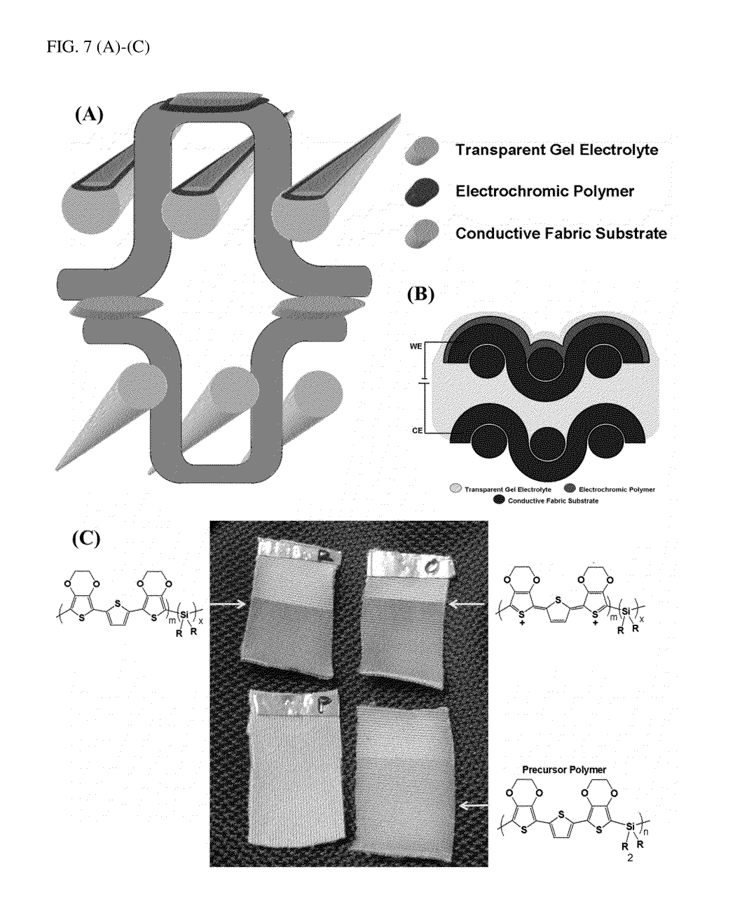

FIG. 7 shows a schematic of an electrochromic device built on woven structure substrates. FIG. 7(A) is a 3-D schematic illustration and FIG. 7(B) is a cross-section of an electrochromic device built on woven structure substrates. FIG. 7(C) are images of a precursor polymer sprayed onto spandex fabric and after conversion to polythiophene.

### Example 5

### All-Organic Electrochromic Fabric Device, Comparison with Woven Stainless Steel and Hybrid Devices

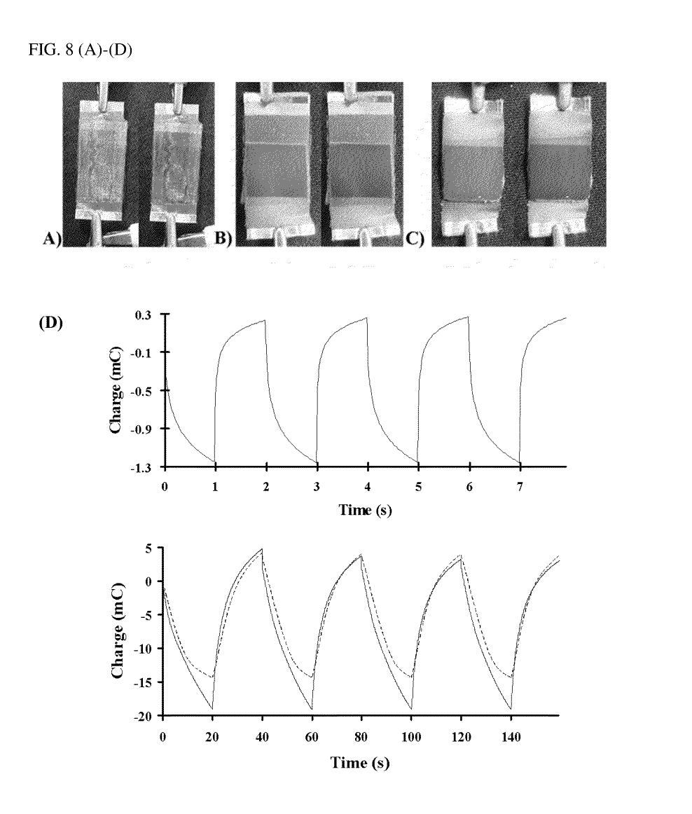

Three woven electrochromic devices were prepared: woven stainless steel mesh substrate (chosen for high conductivity); a hybrid device with stainless steel mesh as the counter electrode and spandex electrode as the working electrode; and an all-organic electrochromic fabric device assembled using two pieces of spandex fabric electrode as shown in FIG. 8(C). It was surprisingly found that the fabric electrodes used to construct the hybrid and all-organic devices need not to be highly conductive although the performance of the electrochromic devices are certainly affected by the lower conductivity of the substrates. The stainless steel mesh device accomplished a switch in 318±33 ms while the all-organic ECD switched in 14.5±0.53 s. The fact that the conductive substrate is limiting the switching speed is further confirmed by that the hybrid device with spandex as the working electrode switched in 13.1±0.14 s, much closer to the two spandex electrodes device rather than the complete metal mesh device. However the slower switching speed should not become an issue in applications like color-changing clothes, billboard signs etc. and its performance can be compensated by the potential stretchability. It is worth noting that the PEDOT in the spandex fabric is subject to the electrochemical redox cycles as well. Comparing the color of the spandex electrode in FIG. 8(B) that is not covered by polythiophene, it can be seen that the color of the spandex electrode visibly switched to a darker blue tone when negative potential was applied. However the reduction is partial as discussed earlier because complete reduction will prevent any further electrochemical switching.

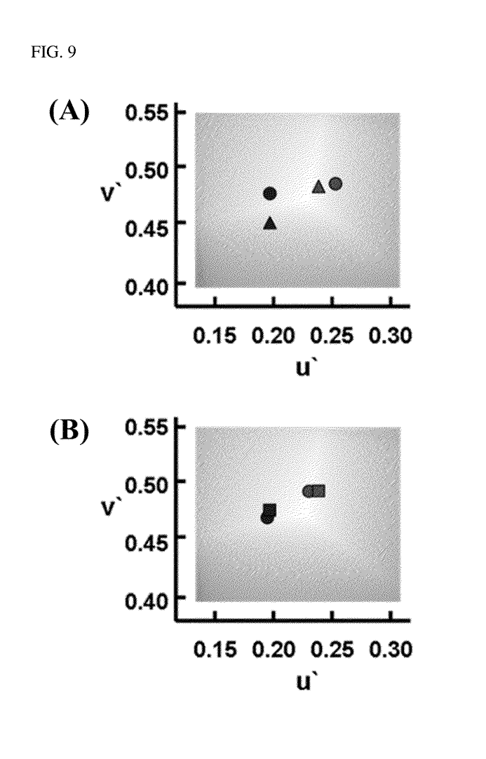

Color characterization was performed using a PhotoResearch PR-670 Colorimeter with a 10° standard observer angle and a measurement range of 360 nm to 860 nm in 1 nm intervals. A black box was used for all the color measurements while a D65 standard illuminant lamp was used as the light source of the system. MS-5× zoom lens with ⅛° aperture was used because of its ability of focusing on the individual threads of the woven textiles (40 μm diameter for metal thread, 100 μm diameter fiber bundles for spandex). The colorimetric results are shown in FIG. 9, all color coordinates are placed in the zoomed-in CIE 1976 Lu′v′ color space for easier visual comparison of the colors. Apart from the data of electrochromic active materials on different substrates, those of bare stainless steel and PEDOT-PSS coated spandex were collected as well. The bare stainless steel mesh was found to be Luminance=29.8, u′=0.2052, v′=0.4505. The neutral state was Luminance=15.5, u′=0.2353, v′=0.4815 and the oxidized state was Luminance=22.7, u′=0.1990, v′=0.4475. For the spandex, the coordinates were Luminance=30.3, u′=0.1942, v′=0.4808. The neutral state was Luminance=10.1, u′=0.2446, v′=0.4957 and the oxidized state was Luminance=11.3, u′=0.2010, v′=0.4864. There is a clear effect of substrate on colors coated on top. The underlying grey, steely color of the metal mesh as contrasted with the light-blue color of the PEDOT-PSS coated spandex cause the variations of color observed on this plot, even though the same active electrochromic material were used for all devices. Stretching the fabric, however, did not distort the color. The colorimeter was focused on individual fiber bundles while stretched and unstretched, and the color coordinates overlapped in each case.

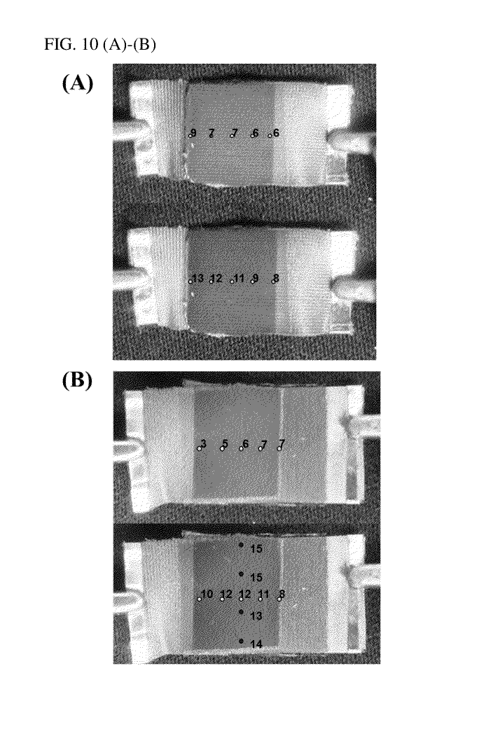

Another result from the lower conductivity of the spandex electrode is the exacerbated iris effect. Electrochromic color change is due to the redox reaction of the material and therefore the speed of the color change is dependent on the rate of the charge flow. In high conductivity substrates like the stainless steel mesh, the flow is so fast that the difference in color change across the device cannot be detected by human eyes. However, when the charge carrier mobility is not high enough, electrochromic color change will start from where the potential is pumped into the system and propagate through the whole device. This phenomenal is called the “iris effect” and can be observed in substrates with lower conductivity like the spandex or in large area devices fabricated with ITO. The optical kinetics of the solid-state fabric ECDs were evaluated with ImageJ software to analyze movies of these devices switching, taken at 25 frames per second. The software maps RGB coordinates with respect to time and distance. Distances over the active area of a device between leads (perpendicular) were divided evenly as shown in FIG. 10; data was analyzed at each point, including edges. The time for the color change front to reach each specific point is listed next to the point in the images of FIG. 10. According to image analysis, there was no iris effect for double stainless steel devices, but a clear effect for spandex steel hybrid and double spandex devices. With the double spandex device, the color change propagated as a front, beginning from one of the leads, whereas the hybrid device demonstrated more of an iris effect. Color changed first on the periphery and progressed inward as indicated by the curvature of the data. Also, as can be seen in FIG. 10(B), the iris effect is mainly observed in the direction of the current flow; in the vertical direction, color change propagates at approximately the same speed.

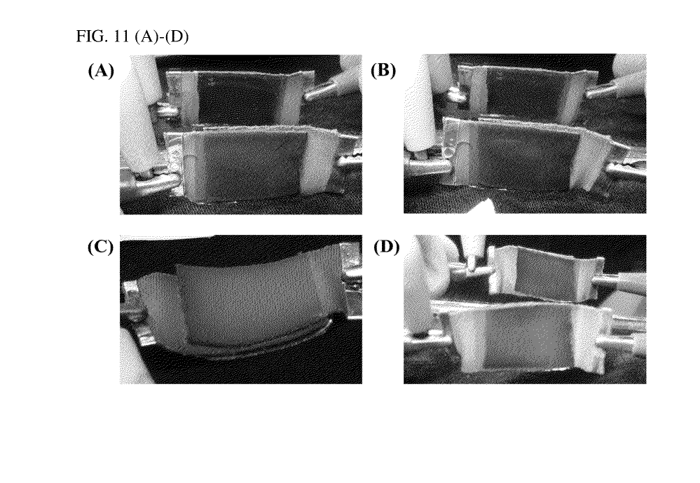

Due to the nature of the fabric substrates, it is not possible to see through the top electrode as in window-type ECD devices. The active electrochromic material, therefore, is coated on the outer surface of the fabric substrate for a reflective color. It is natural to think of coating another layer of the active material on the counter electrode surface and hence have two simultaneous color changes in the same device. Because to the counter electrode is applied the opposite potential of the working electrode, the color changes in such a device would be opposite to each other, i.e. when the electrochromic material switches from blue to red, the material on the counter electrode will undergo color change from red to blue, as shown in FIGS. 11(A) and (B). Further modification on the device structure can result in same color changes on both sides. As shown in FIG. 11(C), one more piece of spandex fabric was sandwiched in between the original two and this piece of spandex electrode was used as the counter electrode. The outer two spandex electrodes, on the other hand, were connected together functioning as the working electrodes. Hence when switched, the outer two electrodes will have the same potential applied and the electrochromic material coated on top will show the same color change while the middle piece take no role in the color change function and is designed only to complete the electric circuit.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All ranges disclosed herein are inclusive and combinable.

The essential characteristics of the present invention are described completely in the foregoing disclosure. One skilled in the art can understand the invention and make various modifications without departing from the basic spirit of the invention, and without deviating from the scope and equivalents of the claims, which follow. Moreover, any combination of the above-described elements in all possible variations thereof is encompassed by the invention unless otherwise indicated herein or otherwise clearly contradicted by context.

What is claimed is:

1. A method of forming a fabric electrochromic device, comprising
inkjet printing a conductive material onto a fabric substrate to form a conductive fabric, and
inkjet printing an electrochromic material onto the conductive fabric.

2. The process of claim 1, wherein the inkjet printing involves high resolution patterning.

3. The process of claim 1, wherein the substrate is a stretchable fabric that is spandex, nylon, or a combination thereof.

4. The process of claim 2, wherein the substrate is a stretchable fabric that is spandex, nylon, or a combination thereof.

5. The process of claim 1, wherein the electrochromic material is a conjugated polymer.

6. The process of claim 4, wherein the electrochromic material is a conjugated polymer.

7. The process of claim 5, wherein the conjugated polymer is a poly(thiophene), a poly(pyrrole), a poly(aniline), poly(acetylene), poly(p-phenylenevinylene) (PPV), a poly(3,4-alkylenedioxyheterocycle), poly(3,4-ethylenedioxythiophene) (PEDOT), poly(3,4-propylenedioxythiophene) (PProDOT), and poly(1,4-bis[(3,4-ethylenedioxy)thien-2-yl)]-2,5-didodecyloxybenzene) P(BEDOT-B), PEDOT-PSS, a poly(vinylpyridine), sulfonated polythieno[3,4-b]thiophene polystyrenesulfonate, a polymer derived from an electrochromic precursor of any one or more of structures (I)-(VIII), or a combination thereof, wherein the structures (I)-(VIII) are 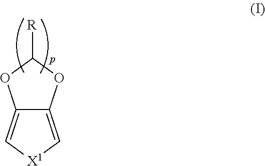
wherein X¹ is NH, S, O, or N-G¹ wherein G¹ is a straight, branched chain, or cyclic, saturated, unsaturated, or aromatic group having from 1 to 20 carbon atoms and optionally 1 to 3 heteroatoms selected from S, O, Si, and N, and optionally substituted with carboxyl, amino, phosphoryl, sulfonate, halogen, or straight, branched chain, or cyclic, saturated, unsaturated, or aromatic group having from 1 to 6 carbon atoms and optionally 1 to 3 heteroatoms selected from S, O, Si, and N; R is H, an O-alkyl group comprising 1 to 20 carbons, or an alkyl group comprising 1 to 20 carbons; 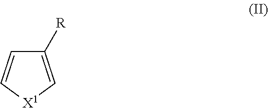
wherein X¹ and R are as defined above; 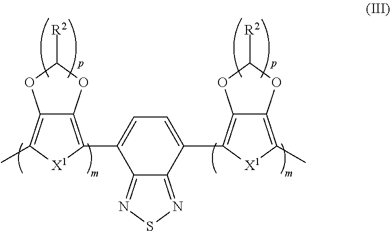
wherein X¹ is as defined above, each instance of R² is independently H, an O-alkyl group comprising from 1 to 20 carbons, or an alkyl group comprising from 1 to 20 carbons, p is an integer from 1 to 20, and m is an integer from 1 to 100; 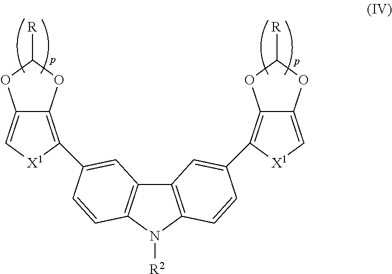
wherein each instance of X¹ independently is as defined above, each instance of R² independently is as defined above, and p is an integer from 1 to 20; 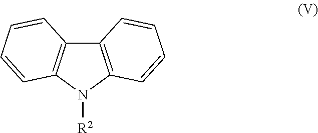
wherein R² is as defined above; 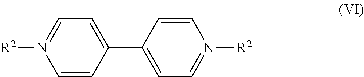
wherein each instance of R² independently is as defined above; 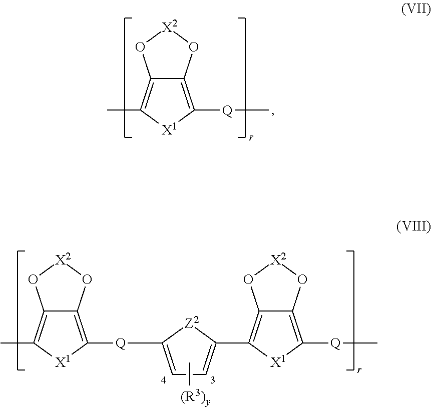
wherein r is an integer greater than 0; y is an integer from 0 to 2; Z¹ and Z² are independently —O—, —NH—, or —S—; X² is an alkylene group comprising 1 to 20 carbons; Q is a silylene group; and R³ is an alkyl or aryl group comprising 1 to 20 carbons attached at the 3 and/or 4 position (shown) of the five-membered ring containing Z².

8. The process of claim 6, wherein the conjugated polymer is a poly(thiophene), a poly(pyrrole), a poly(aniline), poly(acetylene), poly(p-phenylenevinylene) (PPV), a poly(3,4-alkylenedioxyheterocycle), poly(3,4-ethylenedioxythiophene) (PEDOT), poly(3,4-propylenedioxythiophene) (PProDOT), and poly(1,4-bis[(3,4-ethylenedioxy)thien-2-yl)]-2,5-didodecyloxybenzene) P(BEDOT-B), PEDOT-PSS, a poly(vinylpyridine), sulfonated polythieno[3,4-b]thiophene polystyrenesulfonate, a polymer derived from an electrochromic precursor of any one or more of structures (I)-(VIII), or a combination thereof, wherein the structures (I)-(VIII) are 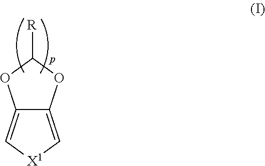
wherein X¹ is NH, S, O, or N-G¹ wherein G¹ is a straight, branched chain, or cyclic, saturated, unsaturated, or aromatic group having from 1 to 20 carbon atoms and optionally 1 to 3 heteroatoms selected from S, O, Si, and N, and optionally substituted with carboxyl, amino, phosphoryl, sulfonate, halogen, or straight, branched chain, or cyclic, saturated, unsaturated, or aromatic group having from 1 to 6 carbon atoms and optionally 1 to 3 heteroatoms selected from S, O, Si, and N; R is H, an O-alkyl group comprising 1 to 20 carbons, or an alkyl group comprising 1 to 20 carbons; 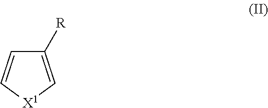
wherein X¹ and R are as defined above; 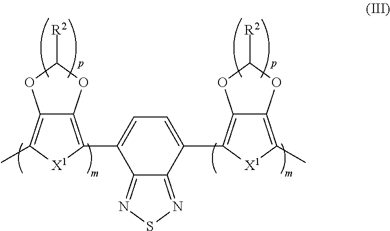
wherein X¹ is as defined above, each instance of R² is independently H, an O-alkyl group comprising from 1 to 20 carbons, or an alkyl group comprising from 1 to 20 carbons, p is an integer from 1 to 20, and m is an integer from 1 to 100; 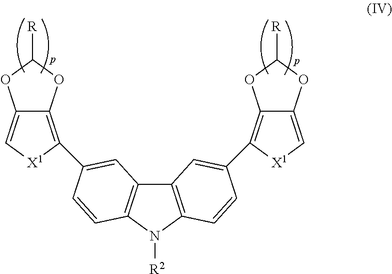
wherein each instance of X¹ independently is as defined above, each instance of R² independently is as defined above, and p is an integer from 1 to 20; 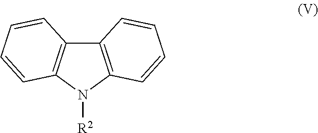
wherein R² is as defined above; 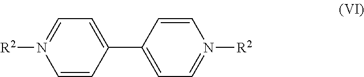
wherein each instance of R² independently is as defined above; 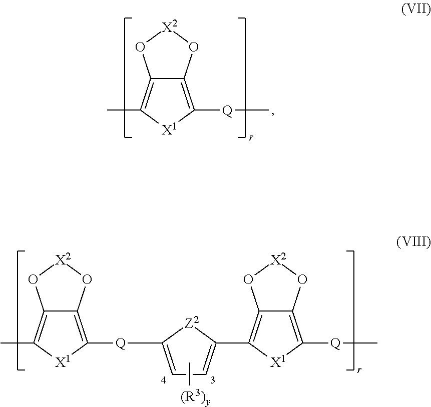
wherein r is an integer greater than 0; y is an integer from 0 to 2; Z¹ and Z² are independently —O—, —NH—, or —S—; X² is an alkylene group comprising 1 to 20 carbons; Q is a silylene group; and R³ is an alkyl or aryl group comprising 1 to 20 carbons attached at the 3 and/or 4 position (shown) of the five-membered ring containing Z².

9. The process of claim 1, wherein the conductive material is PEDOT:PSS.

10. The process of claim 8, wherein the conductive material is PEDOT:PSS.

11. The process of claim 1, wherein the device further comprises a stretchable transparent polymeric electrolyte.

12. The process of claim 10, wherein the device further comprises a stretchable transparent polymeric electrolyte.

13. The process of claim 1, wherein the device further comprises
at least two electrodes, and
a potential source in electrical connection with the at least two electrodes,
wherein at least one of the electrodes comprises the substrate coated with the electrochromic material.

14. The process of claim 12, wherein the device further comprises
at least two electrodes, and
a potential source in electrical connection with the at least two electrodes,
wherein at least one of the electrodes comprises the substrate coated with the electrochromic material.

15. An article comprising a device prepared by a process of claim 1.

16. An article comprising a device prepared by a process of claim 14.

17. The article of claim 15, wherein the article is a garment, and the fabric electrochromic device forms all or a portion of the garment.

18. The article of claim 16, wherein the article is a garment, and the fabric electrochromic device forms all or a portion of the garment.
